(19) United States
(12) Patent Application Publication
(10) Pub. No.: US 2007/0232967 A1
(43) Pub. Date: Oct. 4, 2007

(54) Vibratory Stimulation Apparatus

(75) Inventor: Alan John Driscoll, Middlesex (GB)

Correspondence Address: BREINER & BREINER, L.L.C., P.O. BOX 19290, ALEXANDRIA, VA, 22320-0290, US

(73) Assignee: Twisted Products Limited, Buckinghamshire (GB)

(21) Appl. No.: 11/579,585

(22) PCT Filed: Jan. 23, 2006
(86) PCT No.: PCT/GB06/00228

§ 371 Date: Nov. 6, 2006

(30) Foreign Application Priority Data
Jan. 21, 2005 (GB) 0501322.2

(51) Int. Cl. A61H 1/00

(52) U.S. Cl. 601/46

(57) ABSTRACT

Vibratory stimulation apparatus is described for use in providing pleasurable and/or therapeutic stimulation, particularly of the genital area. In contrast to the phallus or dildo-shaped vibrators well-known in the art, the apparatus of the present invention is of a substantial conical shape, with the vibration generator internally near the tip of the cone. Typically, the cone may be 180 mm wide at its base and 115 mm in height. The amplitude and frequency of the vibration applied may be variable.

This invention relates to vibratory stimulation apparatus.

It is well-established that various areas of the human body respond in a manner giving pleasure to the person concerned to vibratory stimulation. Vibratory massage devices are well-known in the medical treatment of a variety of conditions, and a wide variety of devices, commonly simply called “vibrators”, are manufactured and used for the stimulation of the sexual organs. It is well-established that by applying a vibrating stimulus to the female sexual organs, users are able to experience orgasm, and, in recent years, a very substantial market has developed for vibratory devices which can be so used.

The classic “vibrator” consists of a casing housing batteries and a battery-driven vibratory member, the whole being generally in the shape of a human phallus, or dildo. Separately, a variety of relatively small vibratory units have been developed which may be held against the female sexual organs, e.g. by straps or located in a suitable undergarment and which may be excited into vibration via power supplied through a suitable electrical lead from a small “battery pack”. It is known to provide control apparatus in association with the battery and vibrator components in both sorts of vibrator with a view to varying the frequency or amplitude of the vibration. GB-A-2036560 discloses a vibrator for applying vibrations corresponding to musical signals to stimulate the nervous system.

In accordance with the present invention, the overall shape of the vibrator differs markedly from known types. According generally to the present invention, there is provided vibratory stimulation apparatus consisting of a cone of relatively resilient material having located within it relatively near the apex of the cone a device for generating mechanical vibration, and means for supplying electrical power to the device.

We have found that configuring vibratory stimulation apparatus in this way provides a class of vibrator which has a number of advantages compared to the previous phallic/dildo-shaped variety or the small, vibrator head types. This is believed to flow in part from the much more substantial area of contact which can be established between the user and the vibrator according to the present invention, and, in particular, where the vibrator according to the present invention is used in a fashion such that the point of the cone is located centrally to the body and the pubis rests on the sides of the cone. The semi-angle of the cone shape is preferably such that the tip of the cone does not project materially into the vagina and the weight of the body is then supported via the pubis which, as a result, is subject to vibration which is accordingly transmitted to a greater or lesser degree around the entire pelvic girdle.

The semi-angle of the cone is preferably between 35 and 45°, and a semi-angle of around 38° has been found to be highly satisfactory in practice.

The overall height of the cone is preferably from 100 to 130 mm and the diameter of its base from 150 to 200 mm.

The cone may be made of a variety of resilient materials, the preferred one being a silicone rubber compound.

The external conical surface may be a smooth plain surface or it may be textured, for example ribbed or dimpled.

The vibration generator is located within the cone near its apex and may be selected from a wide variety of such devices as are used in conventional phallus/dildo-shaped devices. The power supply may be located in the base of the cone, for example in a battery casing set into the base of the cone, or the cone may be solid and have a wire lead extending from it at or near its base for connection to a source of power, or a socket may be set into the cone near its base for connection of a power supply using a standard jack or similar plug.

As in the case of conventional phallus/dildo-shaped vibrators, means may be provided in known fashion to vary the amplitude and/or frequency of vibration. Such means may be an externally actuatable control mounted on the apparatus itself, or, for example, one which is hand-held and which may communicate with the apparatus via bluetooth technology in known fashion.

The cone itself may be of essentially solid construction consisting simply of, for example, silicone rubber, or it may have a hollow construction, though care needs to be taken to ensure that the walls, if the cone is of hollow construction, are of adequate strength to stop the cone sagging when weight is applied to the top and sides of the cone. Alternatively, the cone may consist of an internal load-supporting frame or base covered with a cover of resilient material such as silicone rubber.

The use of vibratory stimulation apparatus in accordance with the present invention may be merely to provide the user with pleasurable sensations. Tests have shown that vibrators in accordance with the present invention are capable of producing very substantial pleasurable sensations and of doing so rapidly compared with other vibrator types. One reason for this is believed to be that the application of vibration to the pelvic girdle can provide resonances and act to stimulate the nervous system over a substantially wider area than is influenced by conventional phallus/dildo-shaped vibrators. This in turn is believed to stimulate blood flow into the area, in particular into the vaginal wall, clitoris and labia which is believed to intensify resultant orgasms. The cone-shaped apparatus of the present invention is substantially less penetrative than a conventional phallus/dildo-shaped vibrator and this is preferred by some users.

Continued regular use of the apparatus according to the present invention is capable of providing additional benefits to the user. In particular, the toning effect of vibratory massage is one which can operate particularly effectively on the pelvic floor muscles and other muscles in the pelvic area. It may be of use accordingly not merely for pleasure, but in the treatment of incontinence caused by muscular slackness or wasting.

In this connection, similar stimulating and tightening effects may be obtained if the tip of the cone is located in the centre of the anus where the vibratory massage effect on the anal sphincter may be achieved.

Overall, the general stimulating and toning effect of apparatus in accordance with the present invention can be highly effective in increasing sexual pleasure not merely induced by the individual use of the apparatus, but for both partners in penetrative sexual intercourse.

As indicated above, the apparatus of the invention may have therapeutic application. In a further development, the external surface of the cone may be adapted, for example by the application of suitable surface electrodes, to deliver electrical signals to the skin in contact with the sides of the cone. The operation can be analogous to known TENS or toning pad application used clinically or for slimming and toning products, using the known phenomenon of iontophoresis.

The invention is illustrated by way of example with reference to the accompanying drawings in which:

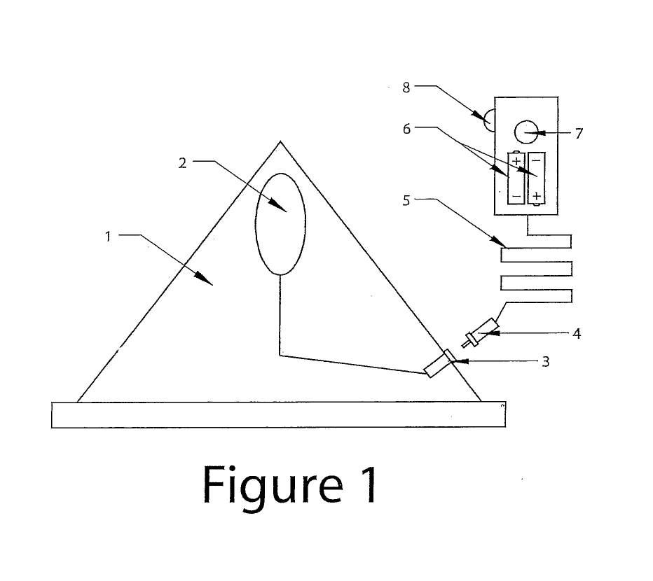

FIG. 1 is a diagrammatic axial section of apparatus according to the invention;

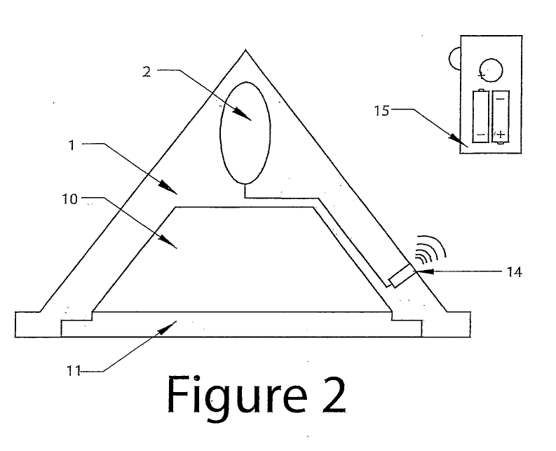

FIG. 2 is a diagrammatic axial section of an alternative embodiment;

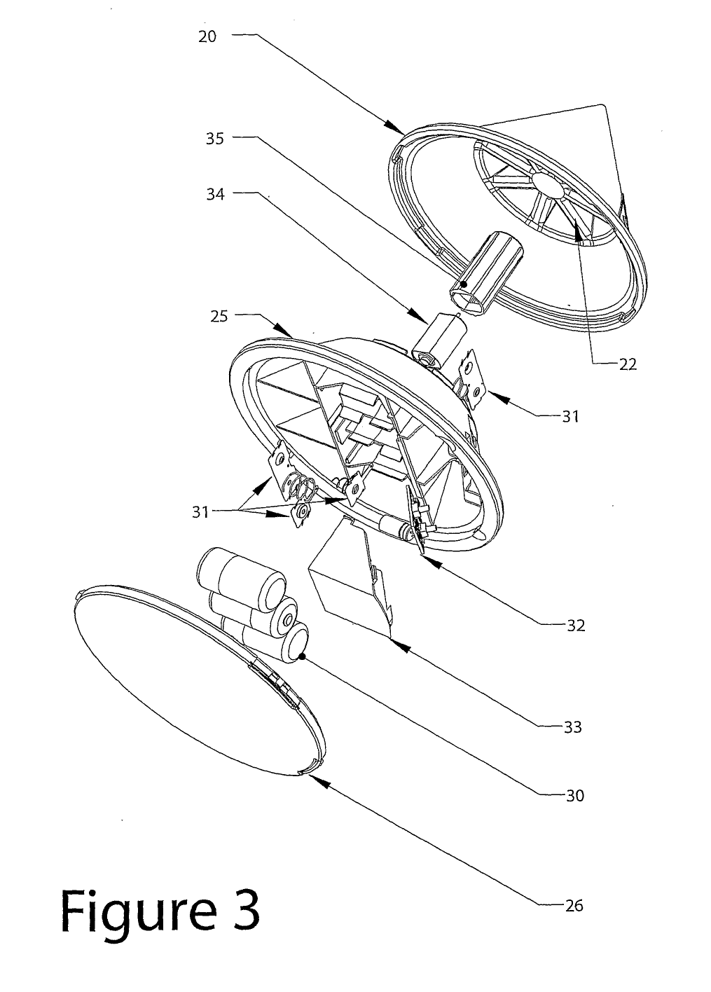

FIG. 3 is an exploded view of a preferred embodiment of the invention, seen from below, and

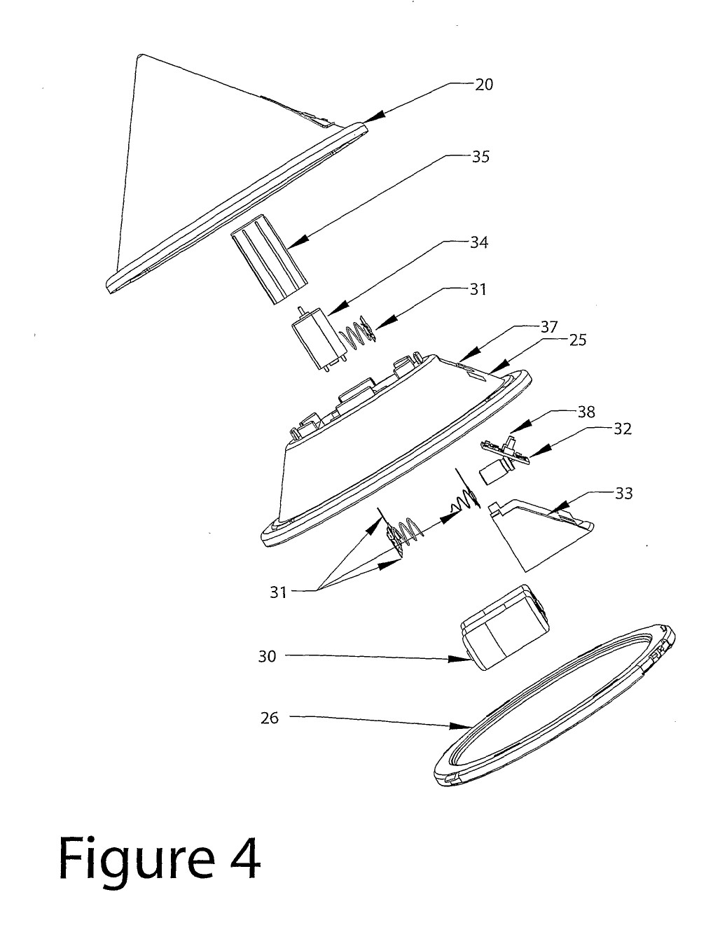

FIG. 4 is a side-exploded view of the apparatus of FIG. 3.

Referring first to FIG. 1, the apparatus shown there consists of a conical block of silicone rubber 1 provided with a base rim. The width of the base rim is around 180 mm and the height of the cone around 115 mm.

Located set in the silicone rubber is a vibrator motor of known type set in an ellipsoidal casing 2. A lead from the lower end of the casing goes to a jack socket 3 which is set into the cone near the rim. That socket can have a jack plug 4 inserted into it which jack plug is connected via a lead 5 to a conventional power supply unit shown diagrammatically and which may have a pair of battery cells 6, an on/off switch 7 and a speed control 8, i.e. a control varying the frequency of the vibrations, e.g. set into one side of a casing for the control unit.

The apparatus shown in FIG. 2 is of similar overall dimensions, but the base of the cone is hollow to provide a compartment 10 closed by a press-in lid 11. The compartment 10 may be an air cavity, or may, for example, be filled with a liquid such as a silicone gel which modifies the overall vibratory characteristics of the cone. Alternatively, it may contain a power supply. In this last case, instead of a jack socket for power supply as in the embodiment shown in FIG. 1, the base of the cone may have an infrared receiver port 14 set into it and this may receive infrared signals from a separate hand-held controller 15 likewise battery powered and provided with appropriate controls enabling the degree of vibration and/or its frequency to be varied. The technology of such remote control units operating via infrared transmission is well-established in the field of television receiver remote control devices and analogous technology may be used in the case of the vibratory stimulation apparatus of the present invention.

Referring now to FIGS. 3 and 4, these Figures show in exploded view a preferred embodiment of the invention.

The device shown in FIGS. 3 and 4 consists basically of an outer silicone rubber moulded cone 20 which is essentially hollow and designed to receive a moulded relatively rigid plastics conical support member 22, and a battery housing and motor assembly casing 25. The circular rim of the cone 20 is rebated to enable a plastics cover 26 to be resiliently located within the outer lip.

As easiest seen in FIG. 3, the housing 25 consists of a generally frusto-conical hollow housing having a transverse battery compartment running across it which is provided when the item is assembled with a number of conventional contact spring assemblies 31. Three “D” cell batteries may be located in the orientation shown between the contact assemblies, and following their insertion between the contact assemblies, the lid 26 may act as a cover.

Housing 25 serves as support for a motor 34 which is of conventional type used in vibratory stimulation apparatus, i.e. it has an internally mounted eccentric so that when the motor is driven, it vibrates. An outer sleeve 35 is adapted to be a press fit over motor 34 and in turn to be located in a central vertical socket in member 22.

All wiring is omitted from the drawings for the sake of clarity, but appropriate wires connect the motor and the battery contact assemblies and are also connected to a small printed circuit board assembly 32 which provides a control for the unit. A moulded plastics cover 33 is adapted to fit to close part of the hollow space within housing 25 to one side of the location of the batteries 30, and to hold the PCB assembly in position within housing 25. When held in its proper position, the ends of two pressure actuatable switches 38 mounted on PCB assembly 32 protrude slightly past apertures 37 in casing 25, resting against the inside of the rubber cone 20.

When the entire item is assembled with the batteries installed, pressure on the outside of the cone on the area against which the end of switch 38 bears will cause the apparatus to be switched on and electrical current to be supplied to the motor 34 which accordingly vibrates and transmits that vibration through sleeve 35, framework 22 and to the upper portion of the resilient cone 20. The pressure must be applied for a certain length of time to do this, the timing being controlled by the circuitry on the PCB assembly 32. Once switched on, the vibration mode may be changed by pressing on the area of the cone overlying the end of the other switch 38, and this may be pressed successively to change the vibration mode through a series of modes programmed into the circuitry of the PCB assembly. When it is desired to switch the vibration off, pressure is applied, again for a period of time determined by the circuitry, to one or other of the areas. The type and sequence of different vibration modes can be varied as desired by appropriate design of the circuitry.

1. Vibratory stimulation apparatus consisting of a cone of relatively resilient material having located within it relatively near the apex of the cone a device for generating mechanical vibration, and means for supplying electrical power to the device.

2. Vibratory stimulation apparatus according to claim 1 wherein the semi-angle of the cone is between 35 and 45°.

3. Vibratory stimulation apparatus according to claim 1 wherein the overall height of the cone is from 100 to 130 mm and the diameter of its base from 150 to 200 mm.

4. Vibratory stimulation apparatus according to any one of claims 1 to 3 wherein the cone is made of a resilient silicone rubber compound.

5. Vibratory stimulation apparatus according to any one of claims 1 to 4 wherein the external conical surface of the cone is textured, ribbed or dimpled.

6. Vibratory stimulation apparatus according to any one of claims 1 to 5 wherein the vibrator generator located within the cone near its apex is connected to a power supply located in the base of the cone.

7. Vibratory stimulation apparatus according to any one of claims 1 to 6 wherein the cone is formed of a hollow outer conical cover of resilient material supported by a conical base or frame of relatively rigid material.

8. Vibratory stimulation apparatus according to any one of claims 1 to 5 wherein the cone is solid and is provided with a wire lead which extends from it at or near its base for connection to a source of power, or includes a socket set into the cone near its base for connection to a power supply using a standard jack or similar plug.

9. Vibratory stimulation apparatus according to any one of claims 1 to 7 and including means to vary the amplitude and/or frequency of vibration.

10. Vibratory stimulation apparatus according to any one of claims 1 to 9 and including means for applying electrical signals to the skin when in contact with the sides of the cone.
